(19) United States
(12) Patent Application Publication
(10) Pub. No.: US 2008/0031707 A1
(43) Pub. Date: Feb. 7, 2008

(54) DEVICE FOR PRODUCING AN ALBUM

(75) Inventors: LAURENT BOURDELAIN, REVEL (FR); PATRICE LAVERGNE, MONTEYNARD (FR)

Correspondence Address: CANTOR COLBURN, LLP, 55 GRIFFIN ROAD SOUTH, BLOOMFIELD, CT, 06002, US

(73) Assignee: KIS, ECHIROLLES (FR)

(21) Appl. No.: 11/768,519

(22) Filed: Jun. 26, 2007

(30) Foreign Application Priority Data
Aug. 1, 2006 (FR) 06 53243

(51) Int. Cl. B42B 5/00

(52) U.S. Cl. 412/33

(57) ABSTRACT

A device for producing a bound album having individual leaves including a unit for folding the leaves in order to configure them to a desired format, a unit for scoring the leaves so as to facilitate folding them and keeping the leaves in their folded form, a pasting unit designed to paste at least some of the leaves two by two after folding, and a delivery board for receiving the scored leaves and for compiling the leaves in order to produce an album, the delivery board being capable of translational movement parallel to a direction in which the leaves are transported inside the device and between several positions in synchronism with operation of the folding unit.

### FIELD OF THE INVENTION

The invention relates to a device for producing an album, especially a photo album, comprising a plurality of leaves articulatedly joined to each other at the level of one of their edges so as to constitute a binding.

The device according to the invention facilitates the production of such albums immediately after producing photographic plates, the latter being advantageously formatted depending on, firstly, the desired page layout and, secondly, the final format of the album.

### DESCRIPTION OF THE PRIOR ART

Currently, semi-automatic production of such albums using photographic plates does not exist. The user has a conventional-style photo album consisting of a plurality of rigid leaves assembled together by means of a hinge. Every leaf is associated with a transparent flap made of plastic film which is used to position the photos as the user wishes.

This type of album is heavy, bulky and has standard dimensions and therefore does not make it possible, for example, to use a number of albums, one for each of the themes of the photos in question.

Given the huge explosion in the number of digital photos, users are increasingly demanding theme-based albums which are appropriate both in terms of size (thickness: depends on number of prints) and format for their prints.

Currently known solutions derived from new printing processes use a sort of digital offset printing which makes it possible to print an individual book using digital files. However, these technical solutions are prohibitively expensive and also require binding machines which are, to a greater or lesser extent, automatic and are also extremely expensive.

Moreover, the technology used has two major drawbacks, namely image quality is far poorer than that of photographic prints and there is a need to centralise production due to the costs and labour involved.

When it comes to digital albums produced from photographic prints, there are non-automatic systems which comprise several separate machines: pasting, binding, cutting etc. which, altogether, are bulky and do not permit automated production.

### BRIEF SUMMARY OF THE INVENTION

The invention proposes a system capable of producing such a photo album directly at the production site or at the point of sale of said prints.

The invention provided for the possibility of producing such albums in a semi-automatic manner.

Thus, the device for producing a bound album including individual leaves comprises:
a unit for folding leaves in order to configure them to the desired format;
a unit for scoring said leaves so as to facilitate folding them and keeping said leaves in their folded form;
a pasting unit designed to paste at least some of the leaves two by two after folding;
a board for receiving the scored leaves and for compiling said leaves in order to produce an album, said delivery board being capable of translational movement between several positions in synchronism with operation of the folding unit.

Integrating these various units in a single system and using the board as a reference frame in order to ensure alignment of the various leaves relative to each other makes it possible to produce an album easily, especially a photo album, without the need for time-consuming, tedious filling of traditional-style photo albums.

The device according to the invention advantageously comprises a unit for automatically measuring the length of the leaves in order to ensure folding substantially or precisely in the middle of said leaf without further information being provided on the part of the operator.

According to the invention, the scoring unit comprises two parallel antagonistic rollers which are rotationally driven in opposite directions, each of the rollers being equipped respectively with a protrusion and a diametrically opposite slot intended to cooperate respectively with a slot and a protrusion of matching dimensions located on the antagonistic roller, the two rollers having at least two areas of tangential contact at the level of the location of the slot and the protrusion.

As a result, said rollers do not have a circular cross-section but each have two flat sections parallel to each other, said rollers being designed so that the flat sections of the two rollers are periodically parallel to each other so as to define an area through which the leaf can pass freely when there is no scoring operation.

According to the invention, the folding unit comprises:
a pair of anterior driving rollers designed to pick up the leaves one by one when they are fed into the device;
a compression cam located downstream relative to the anterior driving rollers and designed to cooperate with a bearing surface, more especially intended to be used to produce the cover of the album in question on the basis of a leaf;
two pairs of posterior driving rollers located downstream relative to the compression cam and operating independently of the anterior driving rollers for the purposes of ensuring folding operations in particular.

According to the invention, the board which, as already stated, is capable of translational movement in a direction parallel to the direction in which the leaves are transported comprises fixed posterior limit stops intended to receive one of the edges of the leaves after scoring and, if applicable, after folding, said board being equipped with retention teeth or limit stops located in the vicinity of the fixed limit stops and actuated by means of a cam which cooperates with a through slit in the frame, said cam thus being operated depending on the location in which the board is positioned.

According to one advantageous aspect of the invention, the pasting unit comprises an independent cassette capable of being inserted by simply sliding it into the frame of the device in order to allow a change of format of the surface area of adhesive to be placed in the spine of the leaves that are to be assembled.

This pasting unit which is described more especially in the patent application filed on the same day by the Applicant is also designed to cooperate with a pressure roll located between the two pairs of posterior driving rollers of the folding unit.

This pasting unit comprises:
a storage spool for a backing covered in a repositionable film of adhesive;
a motor means intended to ensure unwinding of the backing from the storage spool and transport of the latter in a pasting area;
a movable adhesive applicator roll which has two positions:
   an operational position in which said adhesive applicator roll comes into contact with a pressure roll and between which the leaf to be pasted can move;
   and a non-operational position in which the adhesive applicator roll is no longer in contact with the pressure roll or the leaf.

According to the invention, the device is controlled by a programmable logic controller, a PC or logic circuitry comprising one or more printed circuit boards.

These latter components determine, in particular and depending on data entered by the user in terms of format and the number of leaves that constitute the album, the direction of rotation and respective speeds of the various driving rollers of the scoring, folding and pasting units and positioning of the scored line(s).

In fact, the operator simply selects the type of work. In the case of automatic production of an album, the device according to the invention measures and counts the leaves automatically and recognizes the cover (which is inserted last) by its longer length.

The only constraint placed on the operator is to use an adhesive applicator roll having a width suitable for the width of paper used.

### BRIEF DESCRIPTION OF THE DRAWINGS

The way in which the invention is implemented and its resulting advantages will be made more readily understandable by the description of the following embodiment, given merely by way of example, reference being made to the accompanying drawings.

FIG. 1 is a simplified schematic perspective view of the device according to the invention with the board and in a first position the pasting unit is not shown.

FIG. 2 is a view similar to FIG. 1 with the delivery board located in another position.

FIG. 3 is a schematic longitudinal cross-sectional view of the device according to the invention.

FIG. 4 is a schematic review of the delivery board mounted on its transport and guide system in the installation and

FIG. 5 is a view shown at a different angle.

FIGS. 6, 7 and 8 are schematic longitudinal cross-sectional views of the operating principle of the scoring unit of the invention in its non-operational position and in its position to make “A” shaped scores and “V” shaped scores respectively.

FIGS. 9, 10 and 11 illustrate the principle of transporting the leaves inside the device and, in particular, their cooperation with the delivery board.

FIGS. 12, 13, 14 and 15 are schematic views illustrating folding of the intermediate leaves and their pasting.

FIGS. 16, 17 and 18 show production of folding of the leaf intended to serve as the edge or cover of the album and its transport inside the system.

### DETAILED DESCRIPTION OF THE INVENTION

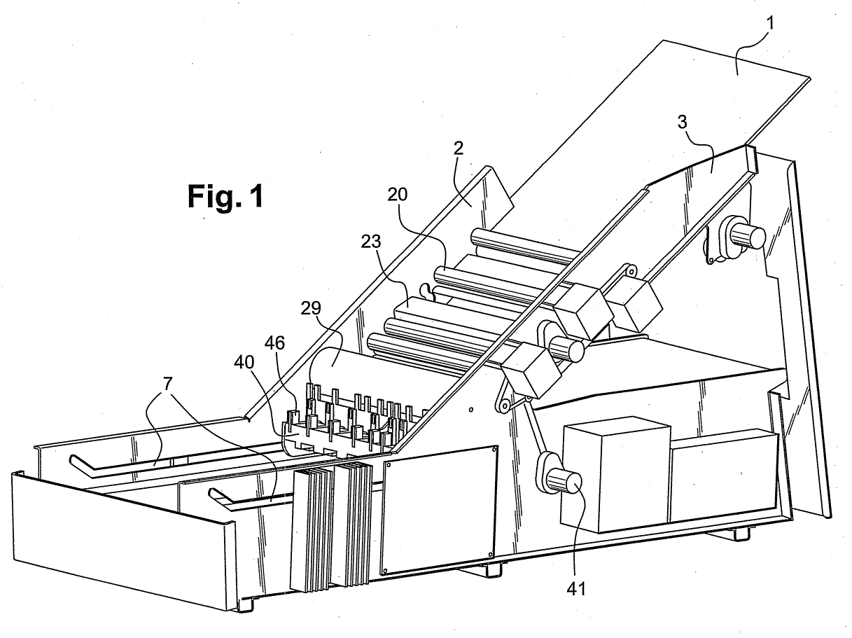

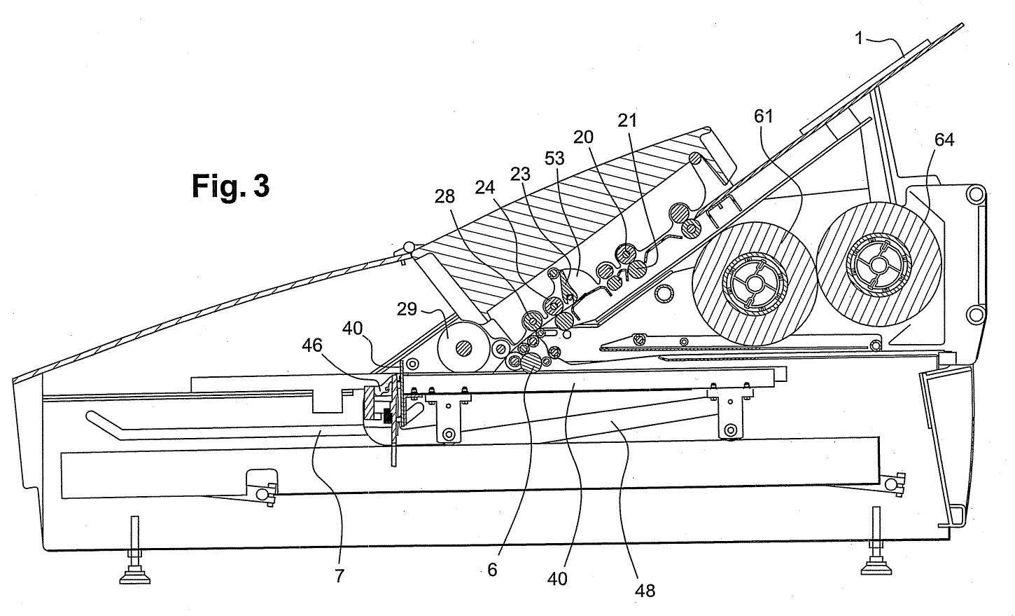

A general view of the device according to the invention is shown in FIGS. 1 to 3.

The device has a relatively compact shape and essentially comprises a plurality of units—scoring, folding and pasting units respectively. These various units are described in detail below.

This device comprises a sloping board (1) for receiving leaves that are to be bound in the form of an album.

More precisely, in the particular context of producing the example described below, the aim is to produce a photo album. This being so, during a stage prior to producing the actual photographic plates, each of the photos is formatted in the device for printing the plates and the sequence of each of the leaves which are to be included in the album to be produced is determined.

In addition, with the help of commercially available appropriate software, the length of the outer leaf intended to form the cover is determined depending on the number of plates which are intended to constitute the photo album in question. Given the fact that this outer leaf is also intended to act as a hinge, it is slightly longer in order to take into account the thickness created by the intermediate leaves, said length therefore being directly correlated to the number of intermediate leaves.

The device according to the invention is also designed so that it can be adapted to suit various types of photographic print formats. This being so, said prints are routed inside the device between two lateral side plates (2) and (3) separated from each other by a clearance which is appropriate to the various foreseeable formats, in particular a width format of typically up to 304 mm. In fact, the distance between the side plates is slightly in excess of the largest format which can be used. It is the angulation of the rollers and the way in which the leaves are inserted which effect their placement against the edge of side plate (3).

At least two reference frames are defined in order to be able to produce a correctly finished album, with its borders aligned, in particular:
a length reference frame comprising a delivery board (40) described in detail below and more especially by limit stops (42) fixedly mounted relative to said movable board with which it is equipped;
and a width reference frame defined by the actual frame of the device and, in this case, by lateral side plate (3).

In addition and advantageously, in order to ensure the leaves are held against lateral side plate (3) as they are transported inside the device, a certain number of rollers which make up the various units, especially the folding unit or the rollers which ensure transport of the leaves inside the system, slope slightly in order to encourage said leaves to move down against lateral side plate (3).

The delivery board according to the invention is first described below. This board (40) is designed to receive leaves subsequent to any prior treatments to which they have been subjected to. It should be noted that all the leaves are subjected to a scoring operation intended, in a known manner, to break or reduce the fibres of the material that constitutes the photographic medium of the leaves in order to facilitate their subsequent folding. Regardless whether these various leaves are folded or pasted or not, they have an edge which always rests against fixed limit stops (42) provided on the posterior edge of the board.

This board is capable of translational movement in a direction parallel to the direction in which the leaves are transported inside the system. To achieve this, it is mounted on a frame (4) which is itself height adjustable and mounted for this purpose on cross members (5) articulatedly fitted on the frame of the system so as to produce a parallelogram. Thanks to the homothetic movement capacity which the board thus has, its height is kept substantially constant over its entire surface area, regardless of the number of leaves which it receives, thus making it possible to perform folding and pasting operations without difficulty.

To achieve this, the board is equipped with an elastic return component, in this case a spring (not shown), the other end of which is attached to the frame of the system so as to cause the board to be pulled back against limit stops comprising a pressure roll (29) and crusher roll (6) which act in this capacity collectively or separately so as to keep the height of the top leaf of the album substantially constant as leaves are deposited on said board, regardless of the number of leaves which the album contains.

In fact and more accurately, it is the height of the upper part of the album which is being made up which is fixed. Thus, the board gradually moves downwards as the album is built up, the reference plane being tangential to the bottom of pressure roll (29) and crusher roll (6), the respective functions of which are described in greater detail later on, said rolls functioning separately or collectively as a limit stop, depending on the effective position of the board on frame (4).

Board (40) is therefore capable of moving on frame (4). One of the sides of the frame comprises a rail (45) which extends substantially over its entire length and is designed to cooperate with a means (44) of matching shape attached to board (40). In order to minimise friction as much as possible, rail (45) is advantageously made of polyamide. This cooperation ensures effective guidance of board (40) on frame (4) during the various translational movements imparted to it during production of the album.

In addition, on the opposite side of frame (4), frame (40) rests on rotatably mounted rollers (43).

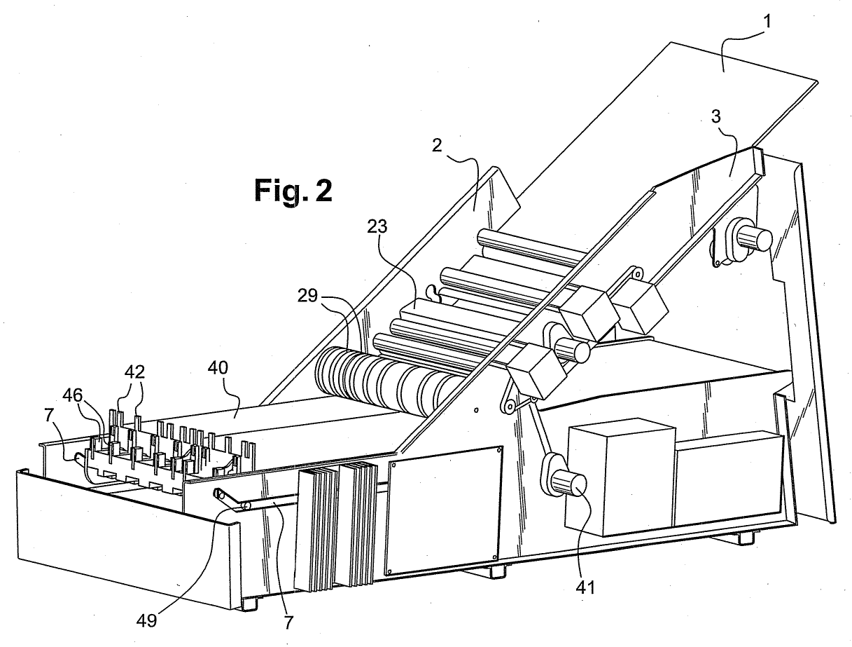

In order to ensure effective translational movement of board (40), it is attached to belt (47) which is joined to two idler rollers mounted on frame (4), said belt being linearly driven by means of electric motor (41) which is shown in FIGS. 1 and 2.

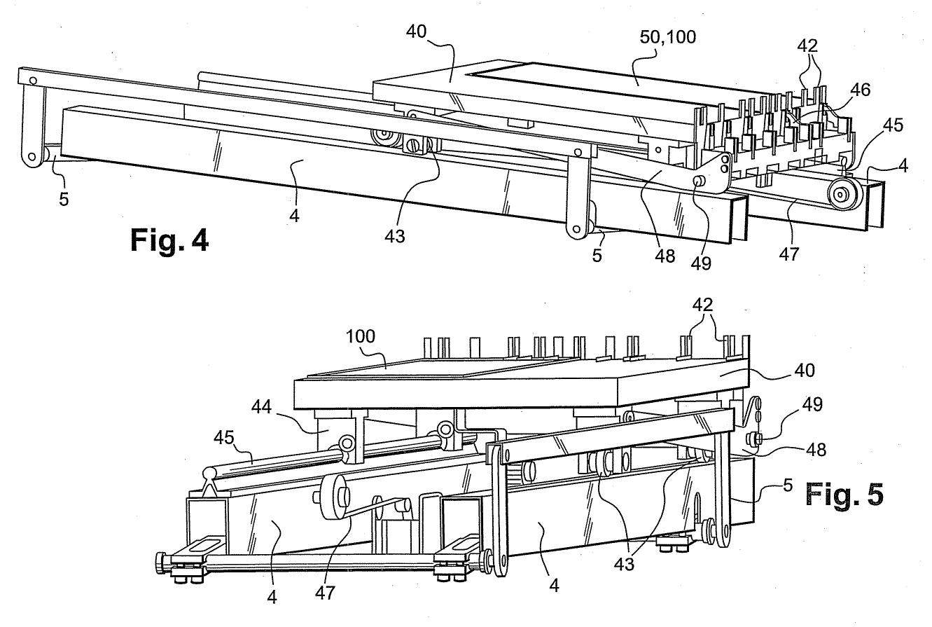

Finally, the board comprises movable limit stops (46) or articulated teeth which fit between fixed limit stops (42), their swivelling relative to their articulation axis being ensured by means of two levers (48) which are themselves articulated in the vicinity of the posterior or downstream end of said board (see FIG. 4) and actuation of which is ensured by cooperation of cam (49) with which they are each equipped and which is accommodated in through slit (7) made in the frame of the system and, especially, in the extension of its lateral side plates (2) and (3). It is apparent that these through slits (7) are straight over substantially their entire length but nevertheless end in two upward portions at their two extremities. The straight area corresponds to lowering of movable limit stops (46) and, more precisely, their cooperation with the leaf or leaves present on board (40) whereas at the end of travel in the upward areas, the movable limit stops are raised and do not interact with the board or the leaves which it carries.

The unit according to the invention for scoring the leaves is described below.

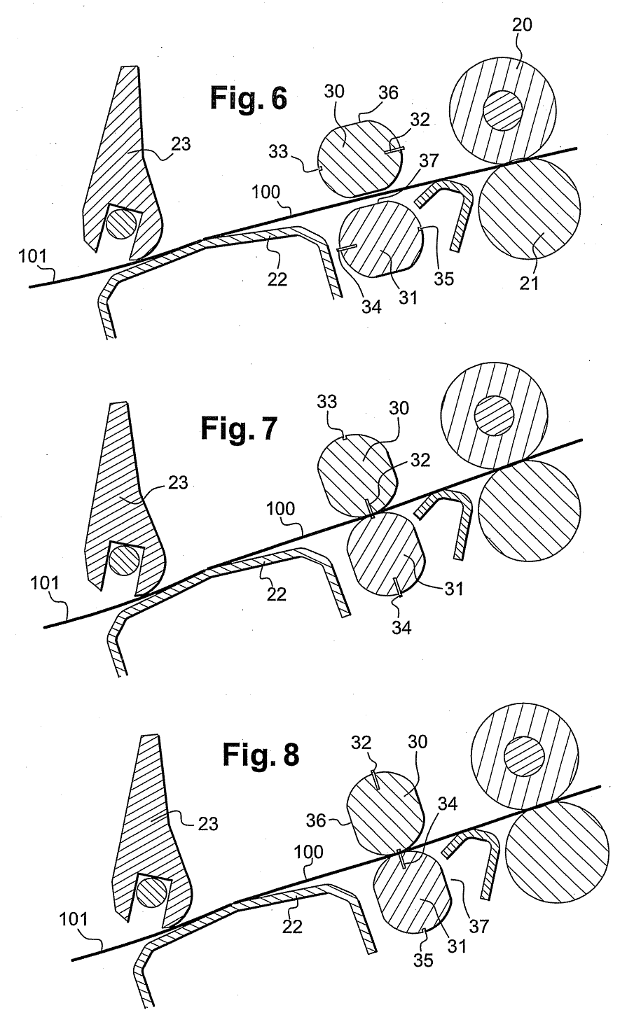

Basically, this scoring unit comprises two parallel rollers (30) and (31) having a non-circular cross-section which is apparent in FIGS. 6 to 8. More precisely, these rollers (30, 31) each have two circular portions that blend into two linear portions which are also referred to as a race-track shape so as to define parallel flat sections (36) and (37) respectively. The flat sections of each of the rollers are periodically parallel with respect to the other roller as shown in FIG. 6 in order to make it possible to define a free space or volume, when the scoring unit is not functioning, suitable for allowing feed of the leaf.

Also, the circular portions of the two rollers (30) and (31) are equipped with a protrusion (32) and (34) respectively substantially in their central areas and with a hollow or relief area (33) and (35) with protrusion (32) of roller (30) being designed to cooperate with opening (35) of roller (31) and, at the same time, protrusion (34) of roller (31) being designed to cooperate with opening (33) of roller (30), the respective dimensions of the protrusions and openings being appropriate, making allowance for the thickness of the leaf to be scored and placed between them. In addition, the centre-to-centre distance between said rollers is selected so that the circular portions of the rollers touch each other in order to also ensure transport of the leaf in this area.

Thus, in FIG. 6, the scoring unit is not operational. In this configuration, the leaf travels freely between the two rollers (30) and (31) between their flat sections with said leaf not being subjected to any scoring.

In contrast, in FIG. 7, the scoring unit is in its operational position in order to make an “A” shaped score. In this configuration, protrusion (34) of roll (31) penetrates into the opening or slot (33) of roller (30), at the same time driving the leaf at this point and causing it to be scored. In this configuration there is an area of tangential contact between rollers (30) and (31) which ensures, as already stated, transport of the leaf in cooperation and in synchronism with, in particular, anterior feed rollers or driving rollers (20) and (21) which are described below.

In other words, rollers (30) and (31) are rotationally driven by a specific electric motor controlled by the programmable logic controller of the device.

In addition, they are made of an appropriate material so as not to prevent or to at least limit any bowing or sagging in order to ensure realisation of an effective, efficient score suitable for facilitating subsequent folding of the leaf in question over its entire width.

FIG. 8 is similar to FIG. 7 apart from the fact that cooperation of the protrusion and the slot respectively is reversed so as to make “V” shaped scores.

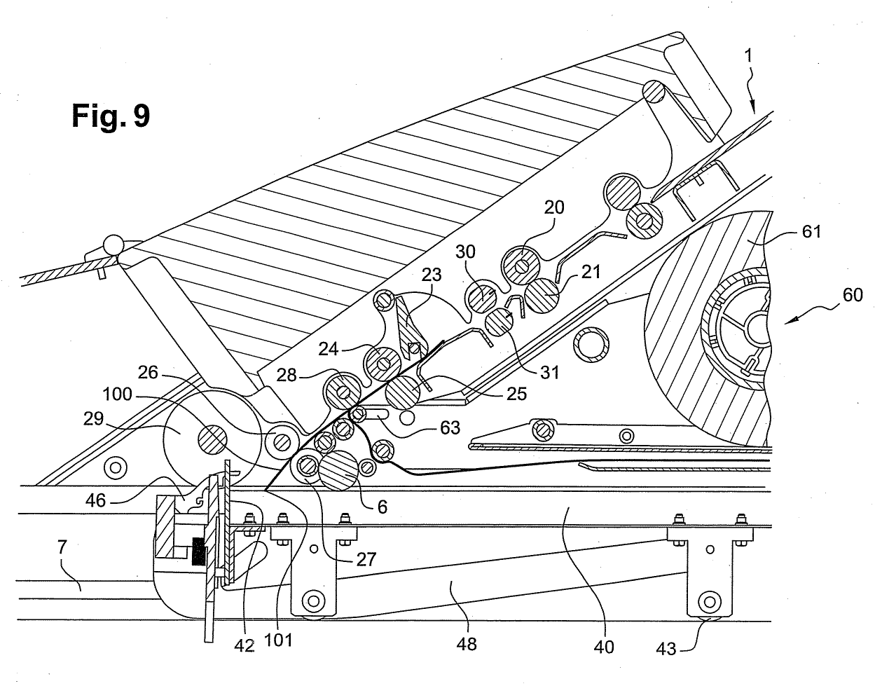

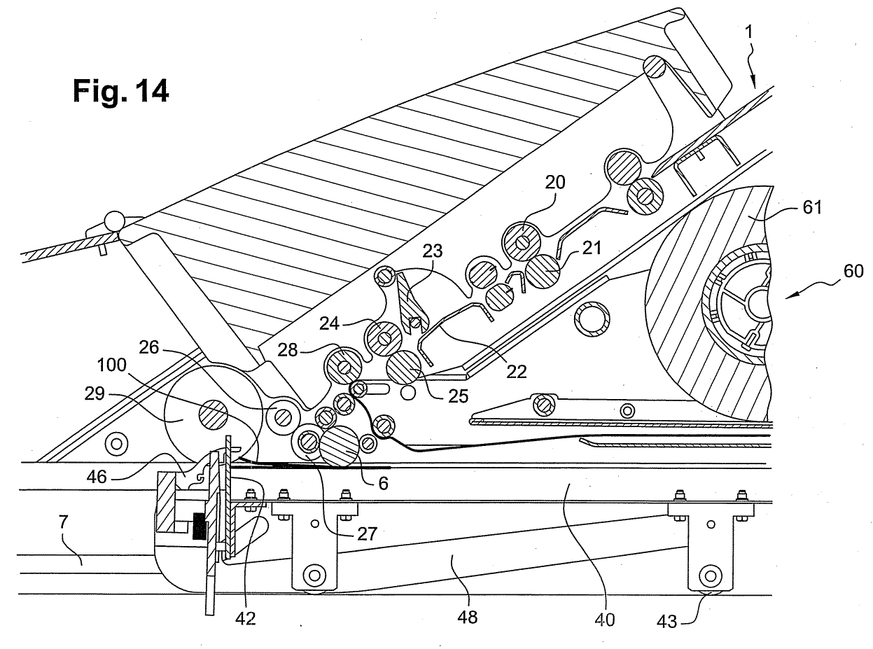

The folding unit according to the invention is described below in detail, reference being made to FIGS. 9 to 18.

This unit cooperates closely with delivery board (40).

As previously stated, it comprises a first pair of anterior driving rollers (20) and (21) which themselves follow a pair of driving rollers (8, 9) for inserting the leaf into the system immediately after sloping plane (1) on which each single leaf obtained after producing the plates is placed.

This folding unit also comprises, to the rear of anterior driving rollers (20, 21) and scoring unit (30, 31), a folding cam (23) designed to cooperate with support (22), this particular structure being described in greater detail below.

The folding unit then comprises, downstream relative to assembly (22, 23), a first pair of posterior driving rollers (24, 25) then a second pair of posterior driving rollers (26, 27) located just upstream from delivery board (40) according to the invention.

The pair of anterior driving rollers (20-21) on the one hand and the two pairs of posterior driving rollers (24, 25) and (26, 27) on the other hand, are capable of operating and, in particular, being actuated independently of each other.

The purpose of this non-synchronous operation of pairs of rollers will be shown below.

FIG. 9 shows a leaf (100) that has been subjected to scoring, the anterior edge (101) of which is in contact with the upper surface of delivery board (40). After scoring, transport of this leaf inside the system is ensured by the two pairs of posterior driving rollers (24, 25) and (26, 27). During this operation, the board is static but located so that cams (49) are located substantially in the middle of the upstream upper portion of through slits (7), thus causing upward swivelling of movable limit stops (46) in order not to obstruct transport of said anterior edge (101) of the leaf towards fixed limit stops (42).

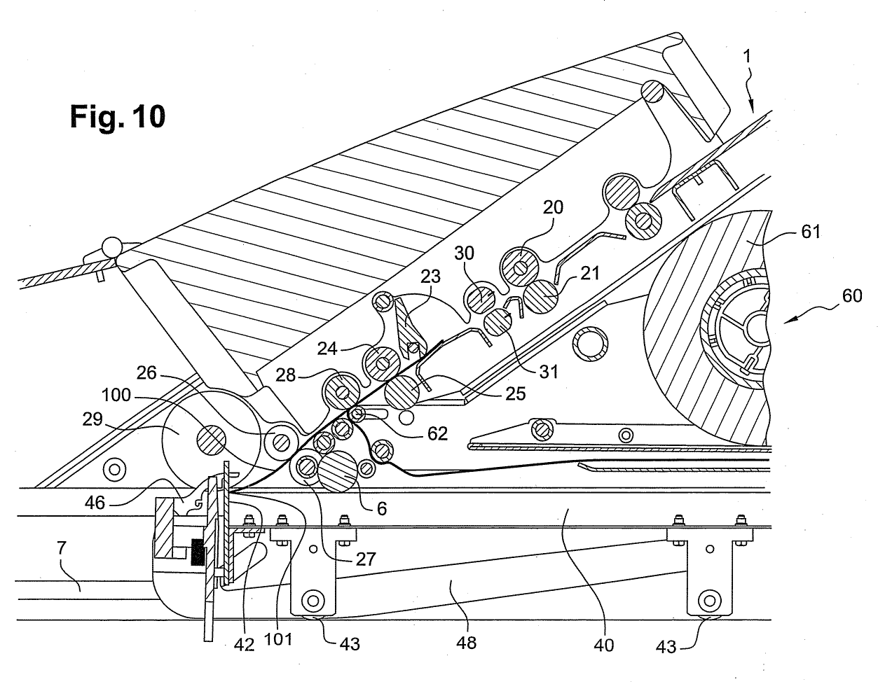

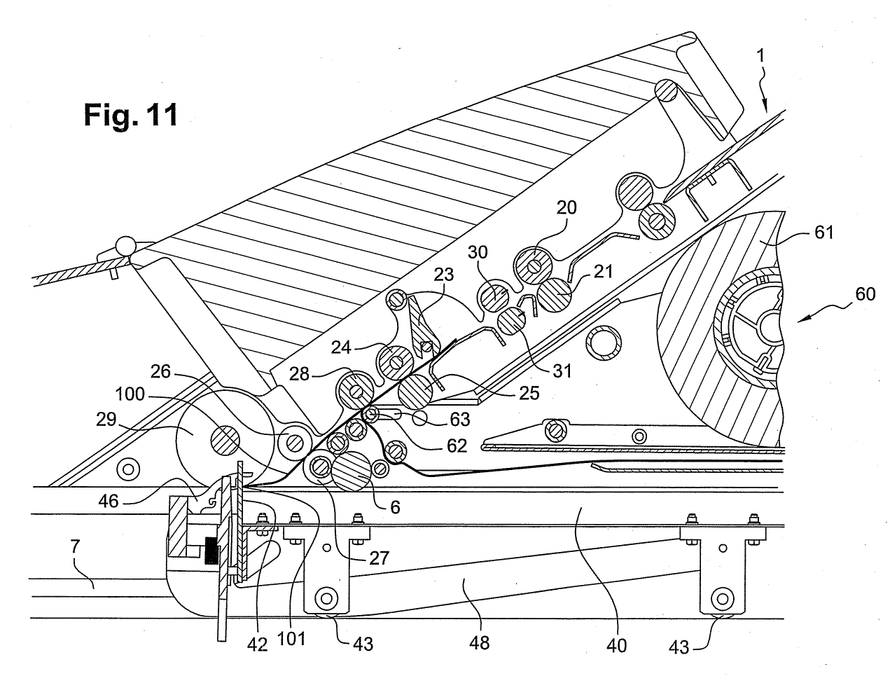

FIG. 10 shows continued transport of leaf (101) due to the action of the two pairs of posterior driving rollers. Board (40) is still static and located in the same position as in FIG. 9. Leaf (100) therefore continues to move until its anterior edge (101) actually presses against fixed limit stops (42) of board (40).

FIG. 11 shows the next step in which one can see continuation of the action of the two pairs of posterior driving rollers even though delivery board (40) is static, thereby causing, because anterior edge (101) of the leaf is pressed against fixed limit stops (42) of the board, curving of said leaf, with downward-pointing convexity which optimises alignment of the leaves relative to each other.

If it is the first leaf, delivery board (40) is subjected to a downstream movement in order to allow complete positioning of said first leaf on board (40).

In contrast, in the case of intermediate leaves, after they have been scored, their first half, being defined between anterior edge (101) and the scoring line, is subjected to pasting by using the pasting unit. This unit actually intervenes in cooperation with pressure roll (28) located between the two pairs of posterior driving rollers (24, 25) and (26, 27). After pasting, this first part of the leaf is positioned in the anterior area of the underlying leaf which is already positioned on the board and slides over this area until it comes up against fixed limit stops (42) of the board in the same way as described in relation to the first leaf.

The following comment should be noted in this respect. In actual fact, pasting only starts several millimetres after the edge of the leaf in question. This being so and taking into account firstly the angle at which said leaf attacks the underlying leaf and secondly the relative rigidity of the material of which is made, it is possible for the leaf to slide until it reaches fixed limit stops (42).

The board moves downstream gradually as said leaf is transported, the speed of motion of the board obviously being synchronised with the transport speed of the leaf and hence the rotation speed of the posterior driving rollers.

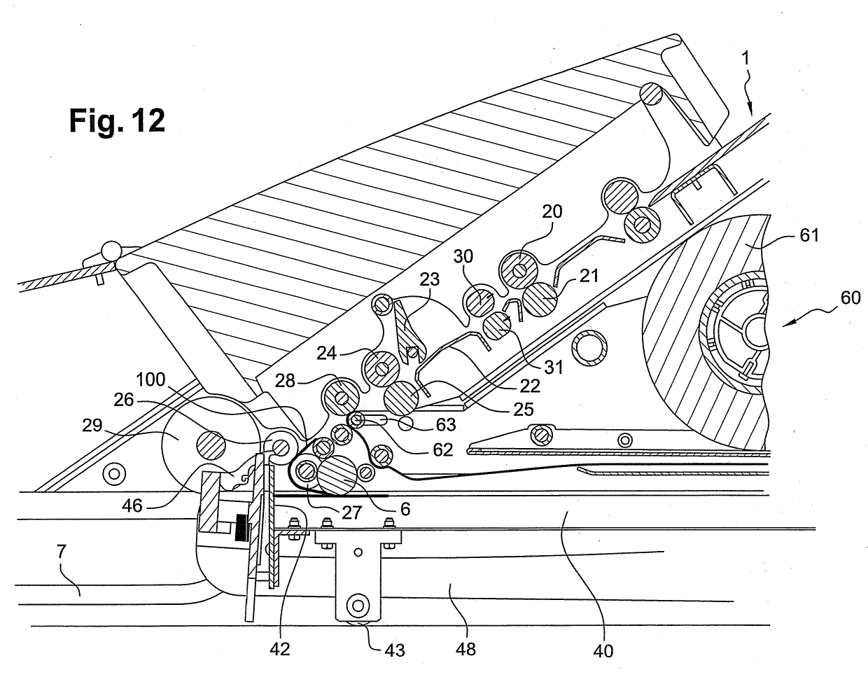

When the pasted half of the leaf thus assembled has been positioned on the leaf or on the stack of underlying leaves, the board stops its downstream movement and returns upstream, thereby causing effective folding of said assembled leaf relative to its scored area which is shown in FIG. 12. To achieve this, posterior driving rollers (26, 27) continue to transport the second part of the leaf in question with consequent downstream movement in the direction of board (40). This being so, the score previously made on said leaf passes underneath a crusher roll (6) (which acts as a height reference: cf. Supra). The pressure produced by the board against this crusher roll (6) acts as a counter-pressure component and causes flattening of the fold at the level of this scoring.

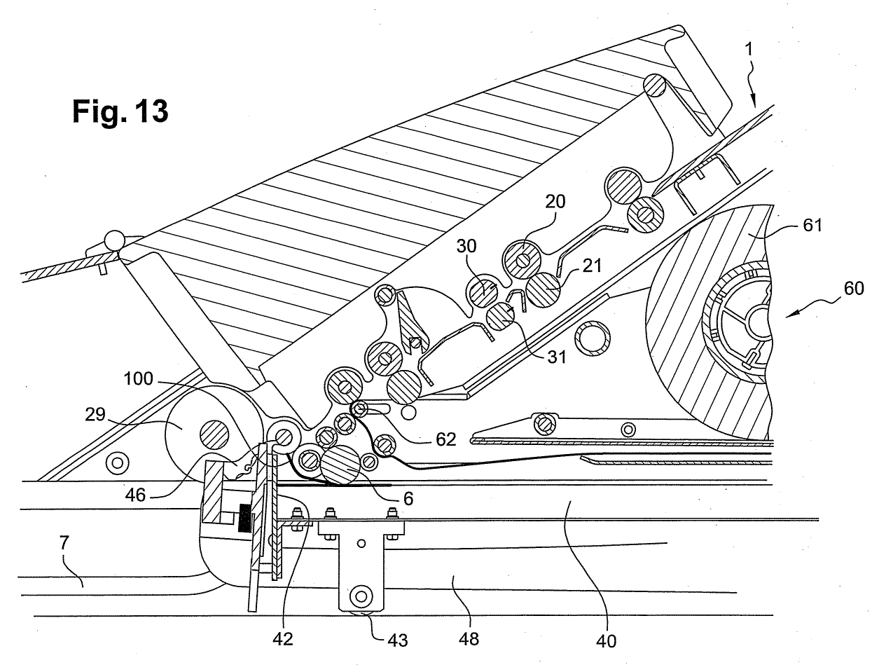

Board (40) continues to move downstream until all of the leaf is released from the pair of driving rollers (27, 28) (FIG. 13) which corresponds to the end of travel, this release allows the free end of the second part of said leaf to fold over said first part naturally and, because of the positioning of the scored area previously made on it and hence folding in its middle, the free edge of this second half naturally presses against fixed limit stops (42) of board (40).

Board (40) then stops moving upstream and returns downstream. As it does this, cams (49) cause swivelling of movable limit stops (46) resulting in the free edge of the second half of the assembled leaf being placed against the first part.

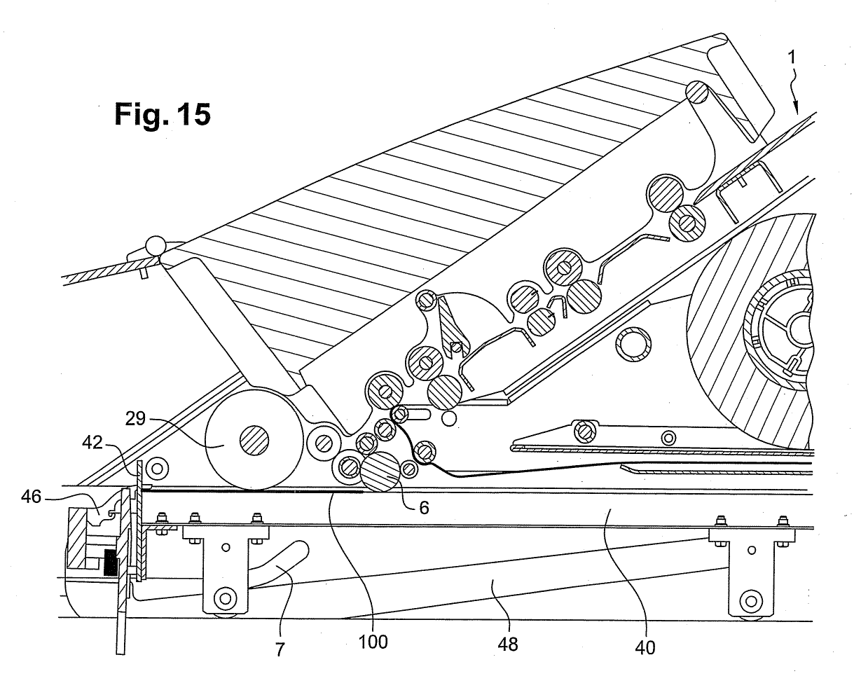

Board (40) continues to move downstream (towards the left in FIG. 15) and causes effective attachment of the leaf thus assembled on the underlying leaf due to the action of pressure roll (29) which exerts pressure on these two or more leaves, said pressure being received by the board itself.

This pressure roll (29) also has radial grooves (29′) having dimensions and, in particular, an appropriate depth and width, to enable movement of fixed limit stops (42) and movable limit stops (46) of board (40) vertically above it and, in particular, movement of the board upstream and downstream relative to this pressure roll (29).

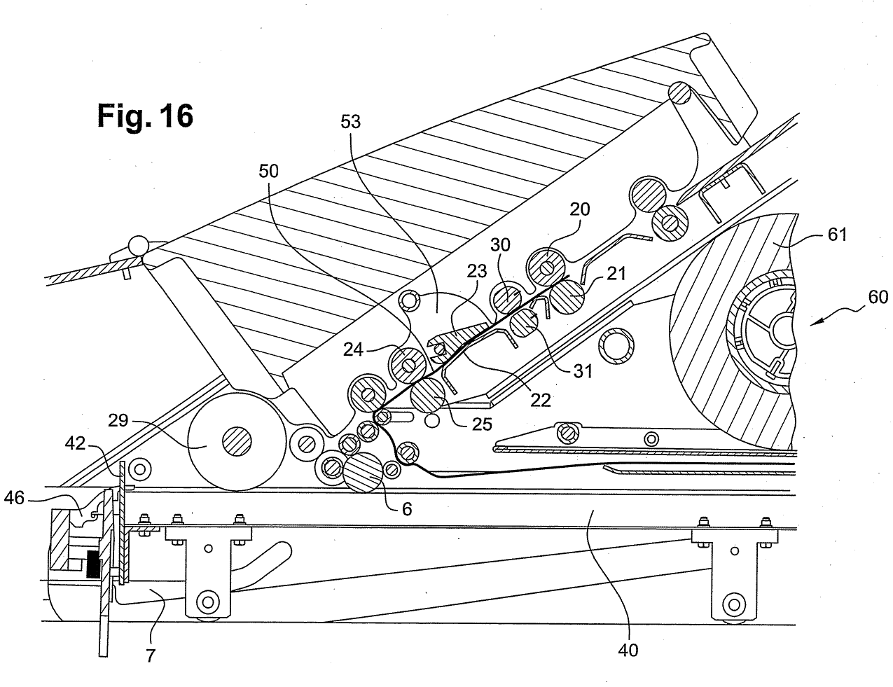

The leaf intended to act as the cover of the album undergoes slightly special processing which is described in greater detail below, reference being made to FIGS. 16 to 18.

This leaf (50) firstly undergoes double scoring in the vicinity of its middle area so as to define two scored lines (51, 52) at “A” and “V” with the distance between these two scored lines depending directly on the predicted thickness of the album which is determined automatically by the programmable logic controller depending on the number of leaves counted by the PLC before detecting the cover by its length which exceeds that of the leaves.

Having been scored, the posterior half of said leaf (50) is held by anterior driving rollers (20, 21) which are static whereas the first pair of posterior driving rollers (24, 25) causes retraction of the leaf within the displacement volume (53) of cam (23). Retraction of the leaf while its posterior area is blocked causes formation of a loop (54) as shown in FIG. 16. One of the two scored lines (51) is located on the loop whereas the other scored line (52) is located substantially at the upstream starting point of said loop.

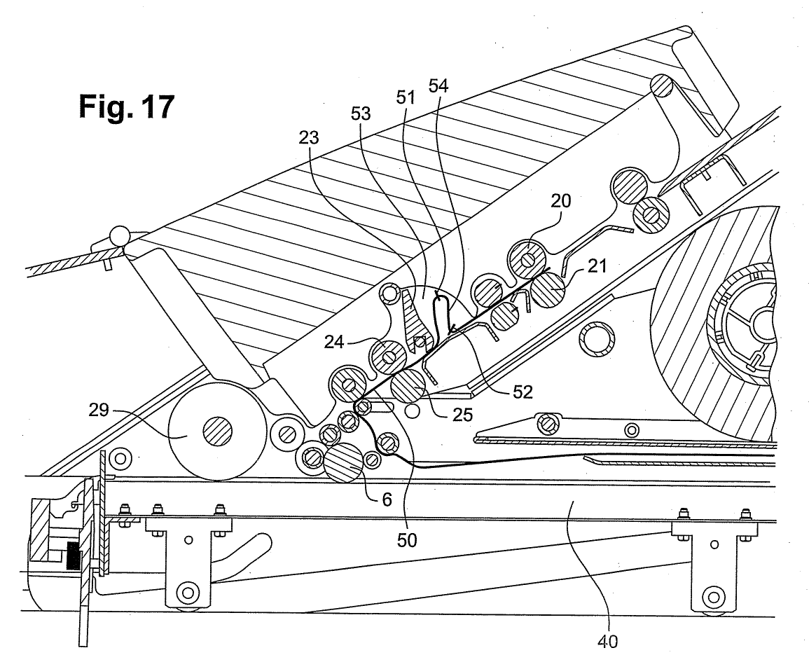

During the subsequent step (FIG. 17), cam (23) is folded back against support surface (22) thus flattening loop (54) thus formed and, consequently, creating two folds at right angles to scored lines (51, 52).

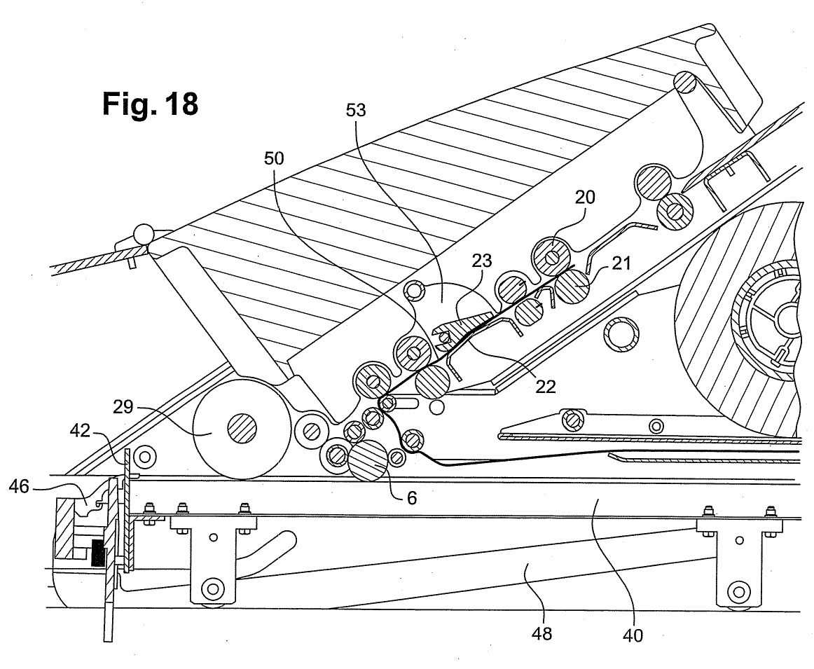

During the next step shown in FIG. 18, cam (23) is once again in its non-operational position and anterior driving rollers (20, 21) operate in reverse in order to pull the leaf backwards, thus eliminating the loop formed during the previous step. Once this operation has been completed, the leaf in question then continues its normal path via the anterior and posterior driving rollers.

Nevertheless, unlike intermediate leaves, this leaf undergoes pasting over its entire surface area, apart from the area that separates the two scored lines which is intended to constitute the hinge of the album.

In addition and as described below, this cover leaf (50) will be attached differently to the rest of the leaves that are already in place on delivery board (40).

Pasting unit (60) which is the subject of a patent application filed on the same day is now described briefly.

It comprises a storage spool (61) for a backing covered in a film of transfer adhesive. This backing is pulled from spool (61) by winding it onto a take-up spool (not shown) for the backing of the adhesive film after pasting when it is therefore free of transferable adhesive—this take-up spool is motor driven.

The pasting unit also comprises an adhesive applicator roll (62) which can move between two positions:
an operational position in which said adhesive applicator roll comes into contact with pressure roll (28) located between two pairs of posterior driving rollers (24, 25) and (26, 27) with the leaf to be pasted being capable of moving between pressure roll (28) and said adhesive applicator roll (62);
and a non-operational position in which the adhesive applicator roll is no longer in contact with the pressure roll or the leaf in question.

The support shaft of adhesive applicator roll (62) is capable of moving within transverse slots (63) in the side plates (2, 3) of the system.

In the absence of any applied force, adhesive applicator roll (62) naturally assumes its operational position; a spring system holds it in this configuration.

Adhesive applicator roll (62) only assumes its non-operational position due to the action of an actuator, operation which also causes a reduction in the intensity of the electric current supplied to the motor of the film take-up spool which ensures tensioning of the adhesive film without any movement.

The two storage spools for the backing covered in transfer adhesive and the backing free of transfer adhesive respectively are mounted on removable shafts (not shown) so as to ensure their interchangeability and, consequently, make it possible to change the format of the backing and hence that of the transferable adhesive film and therefore, consequently, adapt it to match various sizes of leaves to be pasted.

In addition, pasting unit (60) is in the form of a removable cassette capable of being inserted into the system or being removed from the latter very easily in the same way that paper trays are inserted or removed from printers. This being so, the album format can be changed very easily by simply changing the cassette that constitutes pasting unit (60).

The various steps involved in producing an album by means of the system according to the invention are described below.

The first leaf is inserted with its verso facing the user, i.e. with the recto in contact with sloping plane (1). It then simply undergoes a scoring process and is entirely positioned, without folding, on delivery board (40) and is obviously in contact with fixed limit stops (42) which provide a reference frame in terms of length and is placed against side plate (3) which provides a reference frame in terms of width.

The intermediate leaves are inserted one after the other with their verso in contact with sloping plane (1). They are each subjected to scoring. Then, the first half of each of them, i.e. the half located downstream relative to the scored line thus produced, is pasted by means of pasting unit (60).

The first intermediate leaf thus pasted is attached to the first half of said first leaf, i.e. to the half that rests against fixed limit stops (42) of delivery board (40).

In contrast, the first half of subsequent intermediate leaves, also pasted, is attached to the second half of the underlying intermediate leaves which have been folded and folded onto said first half.

Leaf (50) which acts as a cover is also inserted into the system with its verso in contact with sloping plane (1). It is not folded onto itself as stated above but its entire verso is pasted apart from the area that separates the two scored lines (51, 52). The anterior area of the said cover leaf is therefore attached to the second half of the last intermediate leaf whereas the posterior area of the cover leaf is attached to the second half of said first leaf.

At the output of the board, one obtains an album which is opened at its first double page with the recto of this double page facing the board. It is then simply a matter of picking up the album obtained from the system and closing it manually.

Advantageously, the pasted area of each of the leaves does not take up the entire half in question of said leaves but leaves a peripheral area approximately 3 to 5 mm wide which is free of any adhesive, thus making it possible to ensure that the leaves slide against fixed limit stops (42) of delivery board (40) and, in addition, making it possible, advantageously, to avoid the edges of each of the leaves that constitute the album being sticky, including their width dimension.

Advantageously, the system comprises, in the area where the leaves are inserted and hence near sloping plane (1), photoelectric sensors to detect the leaves and measure their length. The measurement thus made is transferred to the programmable logic controller or PC which controls the system and is used to adjust the position of the scored lines and also positioning of the adhesive film by the pasting unit.

It is apparent that the system according to the invention makes it possible to produce photo albums easily, especially theme-based albums, comprising photo media such as that described, for example, in the Applicant's patent application FR 06.50548

1. A device for producing a bound album including individual leaves comprising:
a unit for folding the leaves in order to configure them to a desired format;
a unit for scoring said leaves so as to facilitate folding them and keeping said leaves in their folded form;
a pasting unit designed to paste at least some of the leaves two by two after folding; and
a delivery board for receiving the scored leaves and for compiling said leaves in order to produce an album, said delivery board being capable of translational movement parallel to a direction in which said leaves are transported inside the device and between several positions in synchronism with operation of the folding unit.

2. A device for producing a bound album as claimed in claim 1, further comprising a unit for automatically measuring a length of the leaves in order to ensure folding in a middle of said leaf.

3. A device for producing a bound album as claimed in claim 1, wherein the scoring unit comprises two parallel antagonistic rollers which are rotationally driven in opposite directions, each of the rollers being equipped respectively with a protrusion and a diametrically opposite slot intended to cooperate respectively with a slot and a protrusion of matching dimensions located on the antagonistic roller, the two rollers having at least two areas of tangential contact at the level of the location of the slot and the protrusion.

4. A device for producing a bound album as claimed in claim 3, wherein the rollers have a noncircular cross-section and each have two flat sections parallel to each other, said rollers being designed so that the flat sections of the two rollers are periodically parallel to each other so as to define an area through which the leaf can pass freely when there is no scoring operation.

5. A device for producing a bound album as claimed in claim 1, wherein the folding unit comprises:
a pair of anterior driving rollers designed to pick up the leaves one by one when they are fed into the device;
a compression cam located downstream relative to anterior driving rollers and designed to cooperate with a bearing surface intended to be used to produce a cover of the album in question on the basis of a leaf;
two pairs of posterior driving rollers located downstream relative to the compression cam and operating independently of the anterior driving rollers for the purposes of ensuring the folding operations.

6. A device for producing a bound album as claimed in claim 1, wherein the delivery board comprises posterior limit stops which are fixed relative to said board and intended to receive one of the edges of the leaves after scoring and, if applicable, after folding, in order to act as a reference frame, said board being equipped with retention teeth or limit stops located in a vicinity of fixed limit stops and actuated by means of levers articulated on said board and actuated by means of a cam which cooperates with a through slit in a frame of the device, said cam thus being operated depending on a location in which the board is positioned.

7. A device for producing a bound album as claimed in claim 6, wherein the delivery board is mounted on the frame which is height adjustable and mounted for this purpose on cross members articulatedly fitted on the frame of the device so as to keep a height of the top leaf substantially constant as the album is made regardless of the number of leaves which constitutes it, said board being equipped for this purpose with an elastic return component which pulls the board back against limit stops including a pressure roll and crusher roll which act in this capacity collectively or separately.

8. A device for producing a bound album as claimed in claim 1, wherein the pasting unit comprises an independent cassette capable of being inserted by simply sliding it into a frame of the device in order to allow a change of format of a surface area of adhesive to be placed in a spine of the leaves that are to be assembled.

9. A device for producing a bound album as claimed in claim 8, wherein the pasting unit is designed to cooperate with a pressure roll located between two pairs of posterior driving rollers of the folding unit.

10. A device for producing a bound album as claimed in claim 9, wherein the pasting unit comprises:
a storage spool for a backing covered in a film of transfer adhesive;
a motor means intended to ensure unwinding of the backing from the storage spool and transport of the backing towards a pasting area;
an adhesive applicator roll which can move between two positions:
an operational position in which said adhesive applicator roll comes into contact with the pressure roll and between which the leaf to be pasted can move;
and a non-operational position in which adhesive applicator roll is no longer in contact with the pressure roll or the leaf.

11. A device for producing a bound album as claimed in claim 1, further comprising a pressure roll designed to exert pressure on the leaves to be attached, part of at least one of the leaves having been pasted by the pasting unit and said pressure being received by the delivery board.

12. A device for producing a bound album as claimed in claim 11, wherein the pressure roll also has radial grooves having dimensions and an appropriate depth and width to enable movement of fixed limit stops and movable limit stops of the board vertically above it translational movement of said board.

13. A device for producing a bound album as claimed in claim 1, further comprising a crusher roll designed to act as a counter-pressure component for pressure produced by board in order to cause marking or flattening of a fold in the leaves in a scored area previously produced in the scoring unit.

14. A device for producing a bound album as claimed in claim 1, wherein it is controlled by a programmable logic controller, a PC or logic circuitry which ensures, in particular and depending on data entered by the user in terms of format and the number of leaves that make up the album, a direction of rotation and respective speeds of various driving rollers of the scoring, folding and pasting units and positioning of the scored line(s).
